(19) United States
(12) Patent Application Publication
(10) Pub. No.: US 2007/0162655 A1
(43) Pub. Date: Jul. 12, 2007

(54) Locking device of USB port

(76) Inventor: Chien-Pin Huang, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/349,236

(22) Filed: Feb. 8, 2006

(30) Foreign Application Priority Data
Dec. 23, 2005 (TW) 94222570

(51) Int. Cl. G06F 3/00

(52) U.S. Cl. 710/36

(57) ABSTRACT

A locking device of USB port includes a plugging head and a carrying portion; the plugging head has a connecting channel and a plugging channel at the two ends thereof. The connecting channel provides the alignment-positioning connection to the USB port, and the two sides of the plugging channel have an open hole respectively. The carrying portion has a combined hook at one end thereof. The combined hook performs action by the use of a pressing switch. As one performs pressing action to the pressing switch, the combined hook and the open holes separate making plugging head position at the USB port; while one stops performing the pressing switch, the combined hook connects to the open hole making the plugging head position at the carrying portion.

### BACKGROUND OF THE INVENTION

1. Field of the Invention

The invention relates to a locking device, and more particularly, to a locking device that can lock up the data through the data transmission of USB port to prevent the data from stealing.

2. Description of the Prior Art

Science and technology change with each passing days. Following the popularization of the personal computer as well as the flourishing of the 3C-product, the peripherals having various specifications, components such as joints, plugging heads, and signal cables having different shapes and specifications, weed through the old and to bring forth the new. Ever since the issue of Windows 98 of the Micro-Soft Company, this new data transmission interfaces—the USB (Universal Serial Bus) has become a very hot issue.

In reality, the USB specification has gone to the public by Intel Company as early as 1996, but the operation system at that time did not support the driving function of this interface. The position of this new interface was not definite until the Windows 98 appeared to the market. USB is a specification of a general-purpose interface; it can connect to the peripherals such as the keyboard, the mouse, joystick etc. The connector of the keyboard in the past is a design of a circular one having six pins therein. The mouse has two different connectors having different specifications—a PS2 circular connector and a rectangular connector having 9 pins. This diversified design makes the users create a lot of trouble when it comes to implementing a computer of changing equipments. The function of the USB is to unify these diversified connectors.

The conveniency of the USB relatively results in the seriousness of data let out. Anyone with a portable disc can plug in the USB port of the host computer to steal a copy of the data in the host computer. Therefore, a locking device of USB port appeared on the market is developed.

FIG. 1 is an isometric exploded view of the structure of the locking device of a USB port on the market of the prior art. As shown in FIG. 1, the locking device (1) of the USB port on the market of the prior art includes a moving head portion (11), a main body (12), a sliding switch (13), a connecting block (14) as well as two hooks (15). The sliding switch (13) positions on the main body (12) that can move on the first position (91) and the second position (92). The connecting block (14) secures at an end surface of the main body (12) and extends out of the end surface. The two hooks (15) moving together with the sliding switch (13) positions within the main body (12).

The hook portion (151) of the two hooks (15) is within the connecting block (14) when the sliding switch (13) positions at the first position (91). Therefore, the connecting block (14) can separate from the moving head portion (11), thus make the moving head portion (11) positions at the USB port (not shown in the Figure) to perform the locking of the USB port in order to prevent the data from being read. The hook portion (151) of the hook (15) will extends out of the connecting block (14) as the sliding switch (13) positions at the second position (92). Therefore, the connecting block (14) can connect to the moving head portion (11). By the use of the main body (12) to carry the moving head portion (11) out of the USB port, the USB port can open to use.

The above-mentioned locking device of USB port on the market of the prior art has the following demerits:
1. The locking device (1) of a single USB port can perform separation from all the moving head portions (11); thereby, person who purposely sets his mind on doing something can open the moving head portion (11) by simply using a locking device (1) of the USB port.
2. When it comes to use the locking device (1), the pushing and squeezing of the sliding switch (13) is apt to damage the USB port affecting the securing effect of the moving head portion (11)/or portable disc, and the USB port.
3. Since the locking device (1) is only a single product, the user needs to buy it separately causing low popularity and Low desire for the users.
4. Since the locking device (1) has no luminous device, it often cause inconveniency for the users when it is used in an environment having insufficient lamination.
5. That the locking device (1) occupies a large volume and is hard to put aside relatively lowers the buying desire for the consumers.

Therefore, it has been an urgent plan and improvement project for the manufacturers to resolve the above-mentioned problems.

### SUMMARY OF THE INVENTION

In light of the above-mentioned demerits of the prior art, the invention provides a locking device of USB port that aims to ameliorate at least some of the demerits of the prior art or to provide a useful alternative.

The primary objective of the invention is to provide a locking device of the USB port that makes use of a plugging head that can connect to or separate from USB port to achieve the efficacies of locking the USB port and preventing the data from stealing.

The secondary objective of the invention is to provide a locking device of the USB port that makes use of pressing mode to make a plugging head connect to or separate from the USB port to achieve the efficacies of conveniency and fast using of the locking device.

The other objective of the invention is to provide a locking device of the USB port that adds a light source of LED (light emitted diode) to achieve the efficacy of conveniently using the locking device of the USB port under the environment where the light illumination is insufficient.

The further objective of the invention is to provide a locking device of the USB port that one can put the plugging head aside in the locking device when one does not use it to achieve the efficacies of storing to save space and preventing the loss of plugging head.

Another objective of the invention is to provide a locking device of the USB port that can combine with a portable disc to achieve the efficacy of multifunction in a single machine.

Another objective of the invention is to provide a locking device of the USB port that can make use of the plugging channel providing a position-aligned portion; and the combined hook has a corresponding connection-aligned portion; and by the use of the variation of the dimension and position of the position-aligned portion and the connection-aligned portion to achieve the efficacy that the locking device generates the corresponding cipher code.

In order to achieve the above-mentioned objectives, a locking device of USB port includes a plugging head and a carrying portion; the plugging head has a connecting channel and a plugging channel at the two ends thereof. The connecting channel provides the alignment-positioning connection to the USB port, and the two sides of the plugging channel have an open hole respectively. The carrying portion has a combined hook at one end thereof. The combined hook performs action by the use of a pressing switch. As one performs pressing action to the pressing switch, the combined hook and the open holes separate making plugging head position at the USB port; while one stops performing the pressing switch, the combined hook connects to the open hole making the plugging head position at the carrying portion.

The accomplishment of this and other objectives of the invention will become apparent from the following description and its accompanying drawings of which:

### BRIEF DESCRIPTION OF THE DRAWINGS

FIG. 1 is an isometric exploded view of the structure of the locking device of a USB port on the market of the prior art.

FIG. 2 is an isometric exploded view of the structure of the locking device of a USB port of the invention.

FIG. 3A and FIG. 3B are schematic-and-isometric views showing the push button of the locking device of the USB port of the invention.

FIG. 4A and FIG. 4B are schematic-and-isometric views showing the use and the storing action of the locking device of the USB port of the invention.

FIG. 5A and FIG. 5B are schematic-and-isometric views showing the structure of the multi-cipher code of the locking device of the USB port of the invention.

FIG. 6 is an isometric exploded view of the preferred embodiment of the structure of the locking device combining a portable disc of a USB port of the invention.

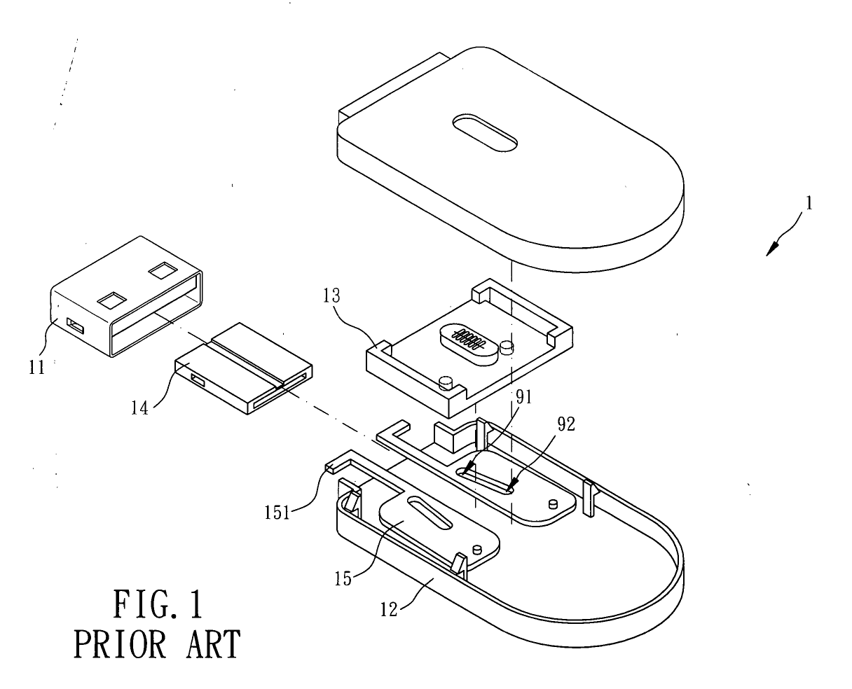

### DETAILED DESCRIPTION OF THE PREFERRED EMBODIMENT

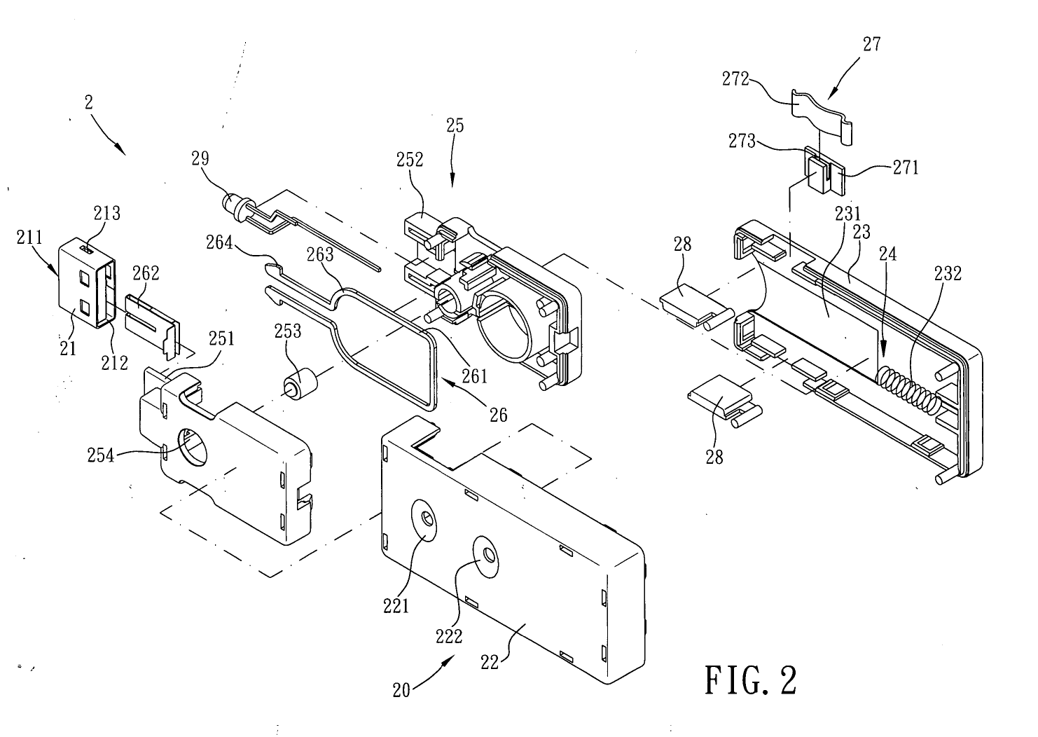

FIG. 2 is an isometric exploded view of the locking device structure of a USB port of the invention. As shown in FIG. 2, the locking device (2) of a USB port includes a plugging head (21) and a carrying portion (20). The plugging head (21) has at its two ends a connecting channel (211) and a plugging channel (212) respectively. The connecting channel (211) provides alignment positioning connection to the USB port (not shown in the Figure) while the plugging channel (212) has at its two ends an open hole (213) respectively. An upper shell (22) and a lower shell (23) combines together to form a carrying portion (20) having between them a containing space (24) that has a resilient member (232) placed therein. Both the upper shell (22) and lower shell (23) provide a shallow channel (231) that makes a slider (25) possible to be contained in the containing space (24). Besides, the slider (25) being pressed against the resilient member (232) can perform linear displacement motion by the use of the shallow channels (231) as a guide and in coordinating with the resilient force of the resilient member (232).

One end of the carrying portion (20) has a combined hook portion (26) consisting of a resilient hook (261) and a guiding seat (262). The resilient hook (261) having resilient force is integrally formed part. It is capable of appearing various angular positions subjected to force exertion and returning to initial state when one releases the exertion force by the use of its inherent resilient force. The carrying portion (20) has a pressing switch (27) at each side thereof respectively. The pressing switch (27) having a pressing key (271) and a resilient piece (272) can press against a pressure-transferring block (28). The pressing key (271) can contain the resilient piece (272) by the use of a guiding groove (273).

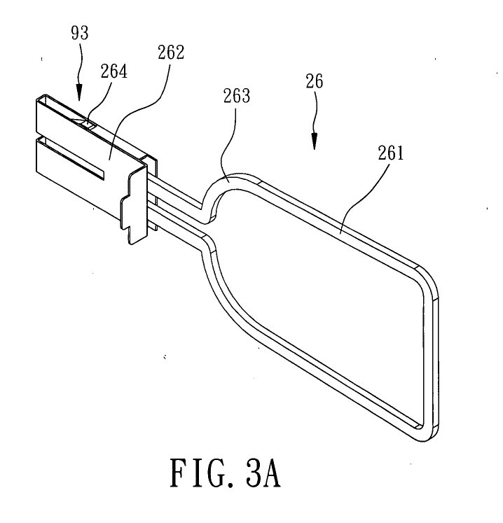

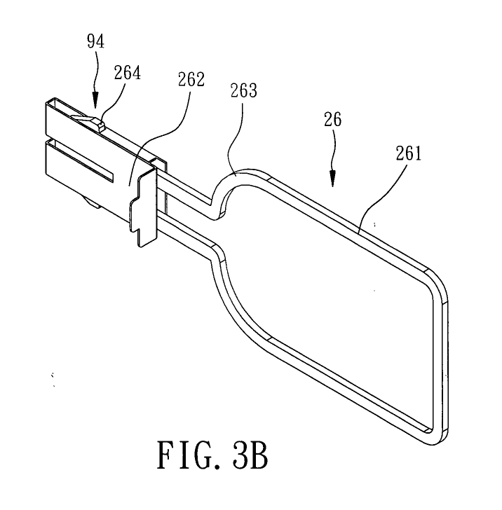

FIG. 3A and FIG. 3B are schematic-and-isometric views showing the push button of the locking device of the USB port of the invention. As shown in FIG. 3A and FIG. 3B, the hook portion (264) of the resilient hook (261) will locate at the third position (93) (see FIG. 3A) in the guiding seat (262) and the resilient hook (261) will separate from the open hole (213) when one exerts force on the pressing switch (27). This is making use of the pressure-transferring block (28) to press against the arc portion (263) of the resilient hook (261). Moreover, the plugging head (21) will position at the USB port (not shown in the Figure). Once the force exerting on the pressing switch (27) releases, the pressing switch (27) will restore back to the initial state by making use of the resilient force inherent in the resilient piece (272). At this moment, the hook portion (264) of the resilient hook (261) will extend up to a fourth position (94) (see FIG. 3B) away from the guiding seat (262) to connect to the open hole (213) making the plugging head (21) position at the carrying portion (20) to form an integrated body.

As shown again in FIG. 2, the slider (25) consists of an upper cover (251) and a lower cover (252). The resilient hook (261) places within the slider (25) to have a joint action. The upper cover (251) having a hole (254) provided therein equips a salient portion (253) disposed in that hole (254).

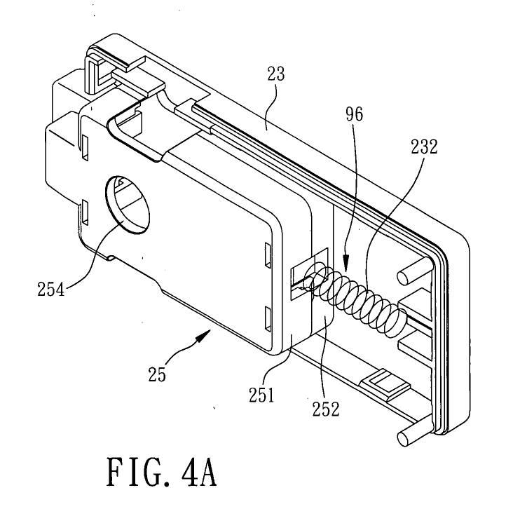

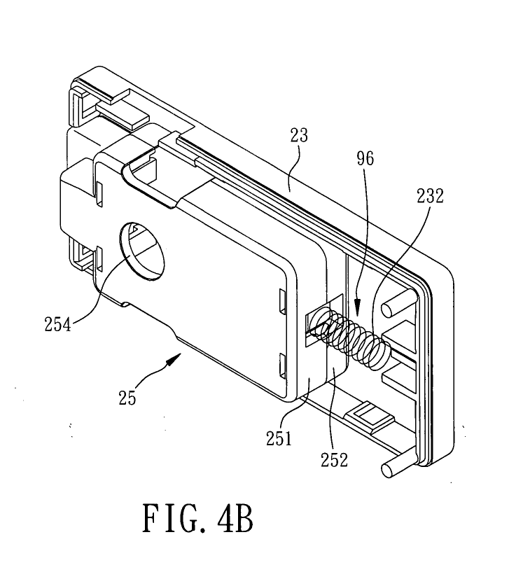

FIG. 4A and FIG. 4B are schematic-and-isometric views showing the use and the storing action of the locking device of the USB port of the invention. As shown in FIG. 4A and FIG. 4B, when it comes to use the locking device of the USB port of the invention, by the use of the resilient force of the resilient member (232), the slider (25) can make the resilient member (232) locate at a fifth position (95). The combined hook (26) extends out of the carrying portion (20). At this moment, the salient portion (253) extends out of a first positioning hole (221). At the storing state, at first, one presses the salient portion (253) into the first positioning hole (221). Then, one exerts force on the combined hook (26) to make the slider (25) press against the resilient member (232) so that the resilient member (232) can locate at a sixth position (96) and the combined hook (26) retracts into the carrying portion (20). Finally, the salient portion (253) will extend away from a second positioning hole to secure.

In the preferred embodiment of the invention, the locking device (2) of the USB port further includes a light source (29) (see FIG. 2) provided at the opposite locations of the carrying portion (20) and the plugging head (21) and is electrically connected to the pressing switch (27). When one presses the pressing switch (27), the light source (29) will perform light radiation to provide illumination.

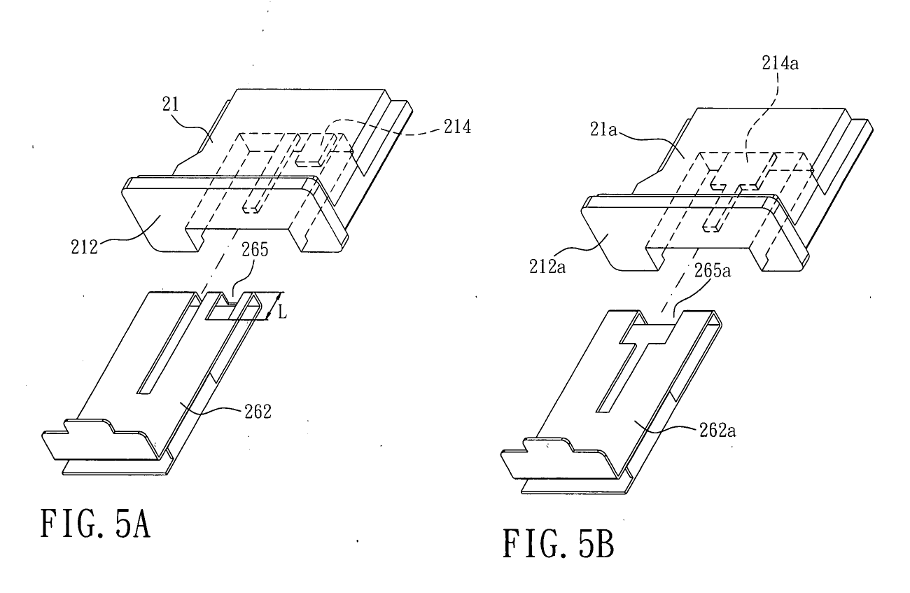

FIG. 5A and FIG. 5B are schematic-and-isometric views showing the structure of the multi-cipher code of the locking device of the USB port of the invention. As shown in FIG. 5A and FIG. 5B, the plugging channel (212) of the plugging head (21) further possesses an offset position-aligned portion (214) therein, and a corresponding connection-aligned portion (265) is provided on the guiding seat (262) of the combined hook (26). This is to make the locking device (2) of the USB port of the invention possesses the efficacy of cipher code. It is capable of changing into various cipher codes by making use of the variation of the dimension “L” and location of the connection-aligned portion (265). As shown in FIG. 5B again, the plugging channel (212) in the plugging head (21a) further equips a position-aligned portion (214a) located in the center portion thereof. As a result, the guiding seat (262a) of the combined hook (26a) disposes also in the center portion thereof. The variation of these makes the carrying portion (20) can have aligned connection only by the use of the corresponding plugging head (21).

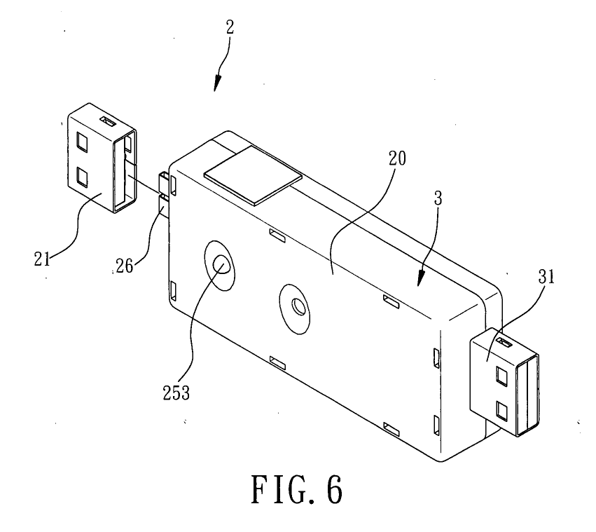

FIG. 6 is an isometric exploded view of the preferred embodiment of the structure of the locking device combining a portable disc of a USB port of the invention. As shown in FIG. 6, the carrying portion (20) of the locking device (2) of the USB port further provides a portable disc (3). A USB transferring head (31) of the portable disc (3) is positioned at the corresponding other end of the combined hook (26). Therefore, one not only can use the portable disc (3) to connect to the host computer for transmitting data each other, but also can use the locking device (2) of the USB port to prevent the USB port from using to achieve the efficacies of multi-function in a single machine.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A locking device of USB port, comprising:
a plugging head having a connecting channel and a plugging channel at the two ends thereof; the connecting channel provides alignment positioning connection to the USB port; and the two sides of the plugging channel have an open hole respectively; and
a carrying portion having a combined hook at one end thereof;
wherein, the combined hook performs action by the use of pressing switch; as one performs pressing action to the pressing switch, the combined hook and the open holes separate making the plugging head position at the USB port; while one stops performing the pressing switch, the combined hook connects to the open holes making the plugging head position at the carrying portion.

2. The locking device of USB port as claimed in claim 1, wherein a light source is provided at the location where the carrying portion meets the corresponding plugging head; the light source being electrically connected to the pressing switch can perform light illumination when one presses on the pressing switch.

3. The locking device of USB port as claimed in claim 1, wherein the combined hook can position at a first position extending out of the carrying portion, and it can position at a second position retracting into the carrying portion.

4. The locking device of USB port as claimed in claim 1, wherein the carrying portion further provides a portable disc therein; and the other end of the carrying portion extends a USB transferring head that can perform alignment-positioning connection with the USB port.

5. The locking device of USB port as claimed in claim 1, wherein the plugging channel further provides a position-aligned portion; and the combined hook provides a corresponding connection-aligned portion

6. A locking device of USB port, comprising:
a plugging head having a connecting channel and a plugging channel at the two ends thereof; the connecting channel provides alignment positioning connection to the USB port; and the two sides of the plugging channel have an open hole respectively; and
a carrying portion having a combined hook at one end thereof; as the combined hook separates from the open holes, one can make the plugging head position at the USB port.
wherein, the plugging channel provides a position-aligned portion therein; and the combined hook further provides a corresponding connection-aligned portion; and by the use of the positions and the dimensions of the position-aligned portion and connection-aligned portion, one can make the plugging head position at the carrying portion when one connects the combined hook to the open holes.

7. The locking device of USB port as claimed in claim 6, wherein the combined hook performs action by the use of pressing switch; as one performs pressing action to the pressing switch, the combined hook and the open holes separate making the plugging head position at the USB port; while one stops performing the pressing switch, the combined hook connects to the open holes making the plugging head position at the carrying portion.

8. The locking device of USB port as claimed in claim 7, wherein a light source is provided at the location where the carrying portion meets the corresponding plugging head; the light source being electrically connected to the pressing switch can perform light illumination when one presses on the pressing switch.

9. The locking device of USB port as claimed in claim 6, wherein the combined hook can position at a first position extending out of the carrying portion, and it can position at a second position retracting into the carrying portion.

10. The locking device of USB port as claimed in claim 6, wherein the carrying portion further provides a portable disc therein; and the other end of the carrying portion extends a USB transferring head that can perform alignment-positioning connection with the USB port.
